(19) United States
(12) Patent Application Publication
(10) Pub. No.: US 2022/0263068 A1
(43) Pub. Date: Aug. 18, 2022

(54) NEGATIVE ELECTRODE PLATE, NON-AQUEOUS ELECTROLYTE SECONDARY BATTERY, AND METHOD OF PRODUCING NEGATIVE ELECTRODE PLATE

(71) Applicant: Prime Planet Energy & Solutions, Inc., Tokyo (JP)

(72) Inventor: Iwao NITTA, Kobe-shi (JP)

(21) Appl. No.: 17/672,572

(22) Filed: Feb. 15, 2022

(30) Foreign Application Priority Data
Feb. 16, 2021 (JP) 2021-022314

(51) Int. Cl. H01M 4/36; H01M 4/587; H01M 4/38; H01M 4/62; H01M 4/04

(52) U.S. Cl. CPC H01M 4/364; H01M 4/587; H01M 4/386; H01M 2004/021; H01M 4/0435; H01M 4/0402; H01M 4/622

(57) ABSTRACT

A negative electrode plate is for a non-aqueous electrolyte secondary battery. The negative electrode plate includes a negative electrode active material layer. The negative electrode active material layer includes a first region, a second region, and a third region. The first region is interposed between the second region and the third region. The first region includes a first carbon material. The second region includes a second carbon material. The third region includes an alloy-based negative electrode active material. An R value of the first region is higher than an R value of the second region.

This nonprovisional application is based on Japanese Patent Application No. 2021-022314 filed on Feb. 16, 2021, with the Japan Patent Office, the entire contents of which are hereby incorporated by reference.

### BACKGROUND OF THE INVENTION

### Field of the Invention

The present technique relates to a negative electrode plate, a non-aqueous electrolyte secondary battery, and a method of producing a negative electrode plate.

### Description of the Background Art

Japanese National Patent Publication No. 2019-508355 discloses a low spring-back carbonaceous material.

### SUMMARY OF THE INVENTION

As a negative electrode active material for a non-aqueous electrolyte secondary battery (which may be simply called “battery” hereinafter), carbon material is widely used. Also, alloy-based negative electrode active material has been researched. Alloy-based negative electrode active material may have a higher specific capacity than carbon material. A battery containing an alloy-based negative electrode active material is expected to have a high capacity. However, an alloy-based negative electrode active material tends to undergo a great extent of volume change during charge and discharge. To address this problem, a mixed system of an alloy-based negative electrode active material and a carbon material is suggested, for example.

In the mixed system, electronic contact points between the alloy-based negative electrode active material and the carbon material tend to be lost. It may be because the carbon material cannot follow the great volume change of the alloy-based negative electrode active material. When the electronic contact points are lost, electrode reaction can become non-uniform and cycle endurance can be degraded.

To suppress the loss of electronic contact points, use of resilient carbon material can be considered, for example. Resilient carbon material is highly resilient to compressional deformation. When the carbon material is highly resilient, the carbon material is expected to be capable of following the volume change of the alloy-based negative electrode active material. Usually, a negative electrode plate of a battery undergoes compression during manufacturing process. When the negative electrode plate includes a resilient carbon material, the negative electrode plate after compression tends to have warpage. The warpage of the negative electrode plate may impair productivity.

An object of the technique according to the present application (herein also called “the present technique”) is to improve cycle endurance of a negative electrode plate including an alloy-based negative electrode active material and a carbon material, while suppressing warpage of the negative electrode plate.

Hereinafter, the configuration and effects of the present technique will be described. It should be noted that the action mechanism according to the present specification includes presumption. The action mechanism does not limit the scope of the present technique.

[1] A negative electrode plate is for a non-aqueous electrolyte secondary battery. The negative electrode plate includes a negative electrode active material layer.

The negative electrode active material layer includes a first region, a second region, and a third region. The first region is interposed between the second region and the third region. The first region includes a first carbon material. The second region includes a second carbon material. The third region includes an alloy-based negative electrode active material. An R value of the first region is higher than an R value of the second region. The R value is determined by the following equation (1):

$$R = {I}_{1360} / {I}_{1580} \qquad ( 1 )$$

where “R” denotes the R value, “I₁₃₆₀” denotes an intensity of a peak at or near 1360 cm⁻¹ in a Raman spectrum, and “I₁₅₈₀” denotes an intensity of a peak at or near 1580 cm⁻¹ in the Raman spectrum.

Generally, the R value of a carbon material is used as an index of graphitization. More specifically, it is considered that, the lower the R value is, the closer the carbon material is to graphite crystal. The R value of an ideal graphite crystal can be zero. It is considered that, the higher the R value is, the closer the carbon material is to amorphous. For example, the R value of amorphous carbon can be more than 1.

According to new findings from the present technique, the R value can also be used as an index of resiliency of a carbon material. It may be because resiliency to compressional deformation correlates with its crystal structure. The lower the R value is, the lower the resiliency of the carbon material tends to be. The higher the R value is, the higher the resiliency of the carbon material tends to be.

In the negative electrode plate according to the present technique, the first region is interposed between the third region and the second region. The third region includes an alloy-based negative electrode active material. Each of the first region and the second region includes a carbon material. During charge and discharge, the rate of volume change of the third region may be higher than the rate of volume change of the first region and that of the second region. The R value of the first region is higher than the R value of the second region. In other words, the first region may be more resilient than the second region. As a result of the first region following the volume change of the third region, electronic contact points are less likely to be lost. In other words, cycle endurance is expected to be improved.

The second region may be less resilient than the first region. With the negative electrode plate including the second region, warpage in the negative electrode plate after compression is expected to be suppressed.

[2] The R value of the first region may be 0.38 or more, for example. The R value of the second region may be less than 0.38, for example.

[3] The first region may further include a first binder, for example.

The first binder may be interposed between the first carbon material and the alloy-based negative electrode active material. With the first binder binding the first carbon material to the alloy-based negative electrode active material, cycle endurance is expected to be enhanced, for example.

[4] The second region may further include a second binder, for example. The second binder may be interposed between the first carbon material and the second carbon material. With the second binder binding the first carbon material to the second carbon material, cycle endurance is expected to be enhanced, for example.

[5] A non-aqueous electrolyte secondary battery includes the negative electrode plate according to any one of [1] to [4] above.

[6] A method of producing a negative electrode plate includes (A) to (C) below:

(A) preparing a mixed composition by mixing a first carbon material, a second carbon material, and an alloy-based negative electrode active material;

(B) forming a negative electrode active material layer including the mixed composition; and

(C) compressing the negative electrode active material layer to produce a negative electrode plate.

The negative electrode active material layer is formed so as to include a first region, a second region, and a third region. The first region is interposed between the second region and the third region. The first region includes the first carbon material. The second region includes the second carbon material. The third region includes the alloy-based negative electrode active material.

The first region is formed so as to have an R value higher than an R value of the second region.

The R value is determined by the following equation (1):

$$R = {I}_{1360} / {I}_{1580} \qquad ( 1 )$$

where “R” denotes the R value, “I₁₃₆₀” denotes an intensity of a peak at or near 1360 cm⁻¹ in a Raman spectrum, and “I₁₅₈₀” denotes an intensity of a peak at or near 1580 cm ⁻¹ in the Raman spectrum.

[7] The first carbon material may have a BET specific surface area of 2 m²/g or less, for example. The second carbon material may have a BET specific surface area of 3.5 m²/g or more, for example.

When the first carbon material has a BET specific surface area of 2 m²/g or less and the second carbon material has a BET specific surface area of 3.5 m²/g or more, the relationship of the R value according to the above [6] tends to be achieved.

[8] The method of producing a negative electrode plate according to [6] or [7] above may include, for example, (a1) to (a3) below:

(a1) preparing a first composition including the first carbon material, the alloy-based negative electrode active material, and a first binder;

(a2) preparing a second composition including the second carbon material; and

(a3) preparing a mixed composition by mixing the first composition and the second composition.

By the method according to [8] above, the negative electrode plate according to [3] above may be produced.

[9] In the method of producing a negative electrode plate according to [8] above, the second composition may include a second binder, for example.

By the method according to [9] above, the negative electrode plate according to [4] above may be produced.

The foregoing and other objects, features, aspects and advantages of the present technique will become more apparent from the following detailed description of the present technique when taken in conjunction with the accompanying drawings.

### BRIEF DESCRIPTION OF THE DRAWINGS

FIG. 1 is a schematic view illustrating an example configuration of a non-aqueous electrolyte secondary battery according to the present embodiment.

FIG. 2 is a schematic view illustrating an example configuration of an electrode assembly according to the present embodiment.

FIG. 3 is an example SEM image.

FIG. 4 is a schematic flowchart illustrating a method of producing a negative electrode plate according to the present embodiment.

### DESCRIPTION OF THE PREFERRED EMBODIMENTS

Next, an embodiment of the present technique (herein also called “the present embodiment”) will be described. It should be noted that the below description does not limit the scope of the present technique. For example, when functions and effects are mentioned herein, it does not limit the scope of the present technique to a certain configuration or configurations where all these functions and effects are exhibited.

Expressions such as “comprise, include” and “have”, and other similar expressions (such as “be composed of”, “encompass, involve”, “contain”, “carry, support”, and “hold”, for example) herein are open-ended expressions. In an open-ended expression, in addition to an essential component, an additional component may or may not be further included. The expression “consist of” is a closed-end expression. The expression “consist essentially of” is a semiclosed-end expression. In a semiclosed-end expression, an additional component may further be included in addition to an essential component, unless an object of the present technique is impaired. For example, a component that is usually expected to be included in the relevant field to which the present technique pertains (such as inevitable impurities, for example) may also be included as an additional component.

The words “may” and “can” herein are not intended to mean “must” (obligation) but rather mean “there is a possibility” (tolerance).

A singular form (“a”, “an”, and “the”) herein also includes its plural meaning, unless otherwise specified. For example, “a particle” may include not only “one particle” but also “a group of particles (powder, particles)”.

The order for implementing two or more steps, operations, processes, and the like included in a method herein is not particularly limited to the described order, unless otherwise specified. For example, two or more steps may proceed simultaneously.

In the present specification, when a compound is represented by a stoichiometric composition formula such as “LiCoO₂”, for example, this stoichiometric composition formula is merely a typical example. Alternatively, the composition ratio may be non-stoichiometric. For example, when lithium cobalt oxide is represented as “LiCoO₂”, the composition ratio of lithium cobalt oxide is not limited to “Li/Co/O=1/1/2” but Li, Co, and 0 may be included in any composition ratio, unless otherwise specified.

A numerical range such as “from 1 m²/g to 2 m²/g” and “from 1 to 2 m²/g” herein includes both the upper limit and the lower limit, unless otherwise specified. That is, “from 1 m²/g to 2 m²/g” and “from 1 to 2 m²/g” mean a numerical range of “not less than 1 m²/g and not more than 2 m²/g”. Moreover, any numerical value selected from a certain numerical range may be used as a new upper limit and/or a new lower limit. For example, any numerical value from a certain numerical range and any numerical value described in another location of the present specification may be combined to create a new numerical range.

Any geometric term herein (such as “parallel”, for example) should not be interpreted solely in its exact meaning. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. The dimensional relationship (in length, width, thickness, and the like) in each figure may have been changed for the purpose of assisting the understanding of the present technique. Further, a part of a configuration may have been omitted.

<Non-Aqueous Electrolyte Secondary Battery>

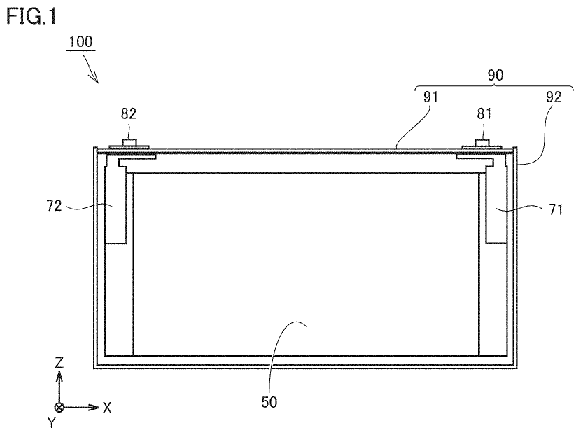

FIG. 1 is a schematic view illustrating an example configuration of a non-aqueous electrolyte secondary battery according to the present embodiment.

A battery 100 may be used for any purpose of use. For example, battery 100 may be used as a main electric power supply or a motive force assisting electric power supply in an electric vehicle. A plurality of batteries 100 may be connected together to form a battery module or a battery pack.

Battery 100 includes a housing 90. Housing 90 is prismatic (a flat, rectangular parallelepiped). However, prismatic is merely an example. Housing 90 may have any configuration. Housing 90 may be cylindrical or may be a pouch, for example. Housing 90 may be made of aluminum (Al) alloy, for example. Housing 90 accommodates an electrode assembly 50 and an electrolyte (not illustrated). Housing 90 may include a sealing plate 91 and an exterior can 92, for example. Sealing plate 91 closes an opening of exterior can 92. Sealing plate 91 and exterior can 92 may be bonded together by laser beam welding, for example.

Sealing plate 91 is provided with a positive electrode terminal 81 and a negative electrode terminal 82. Sealing plate 91 may further be provided with a gas-discharge valve and the like. Electrode assembly 50 is connected to positive electrode terminal 81 via a positive electrode current-collecting member 71. Positive electrode current-collecting member 71 may be an Al plate and/or the like, for example. Electrode assembly 50 is connected to negative electrode terminal 82 via a negative electrode current-collecting member 72. Negative electrode current-collecting member 72 may be a copper (Cu) plate and/or the like, for example.

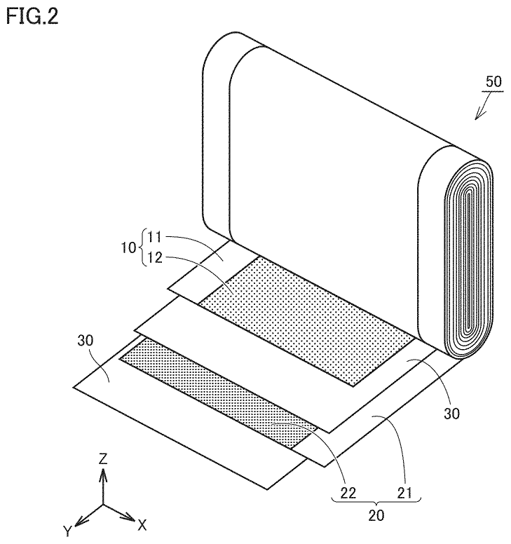

FIG. 2 is a schematic view illustrating an example configuration of an electrode assembly according to the present embodiment.

Electrode assembly 50 is a wound-type one. Electrode assembly 50 includes a positive electrode plate 10, a separator 30, and a negative electrode plate 20. In other words, battery 100 includes positive electrode plate 10, negative electrode plate 20, and the electrolyte. Each of positive electrode plate 10, separator 30, and negative electrode plate 20 is a belt-shaped sheet. Electrode assembly 50 may include a plurality of separators 30. Electrode assembly 50 is formed by stacking positive electrode plate 10, separator 30, and negative electrode plate 20 in this order and then winding them spirally. Positive electrode plate 10 or negative electrode plate 20 may be interposed between separators 30. Each of positive electrode plate 10 and negative electrode plate 20 may be interposed between separators 30. After the winding, electrode assembly 50 may be shaped into a flat form. The wound-type is merely an example. Electrode assembly 50 may be a stack-type one, for example.

<<Negative Electrode Plate>>

Negative electrode plate 20 includes a negative electrode active material layer 22. Negative electrode plate 20 may consist essentially of a negative electrode active material layer 22. Negative electrode plate 20 may further include a negative electrode substrate 21, for example. Negative electrode substrate 21 is a conductive sheet. Negative electrode substrate 21 may be a Cu alloy foil and/or the like, for example. Negative electrode substrate 21 may have a thickness from 5 μm to 30 μm, for example. Negative electrode active material layer 22 may be placed on the surface of negative electrode substrate 21, for example. Negative electrode active material layer 22 may be placed on only one side of negative electrode substrate 21, for example. Negative electrode active material layer 22 may be placed on both sides of negative electrode substrate 21, for example. From one end in a width direction (in the X-axis direction in FIG. 2) of negative electrode plate 20, negative electrode substrate 21 may be exposed. To the exposed portion of negative electrode substrate 21, negative electrode current-collecting member 72 may be bonded.

Negative electrode active material layer 22 may have a thickness from 10 μm to 200 μm, or may have a thickness from 50 μm to 100 μm, for example. The higher the density of negative electrode active material layer 22 is, the more likely the warpage of negative electrode plate 20 is to occur. In the present embodiment, even when the density of negative electrode active material layer 22 is high, warpage of negative electrode plate 20 may be suppressed. Negative electrode active material layer 22 may have a density from 0.5 g/cm³ to 2.0 g/cm³, or may have a density from 0.8 g/cm³ to 1.5 g/cm³, or may have a density from 1.0 g/cm³ to 1.2 g/cm³, for example. Herein, the density of negative electrode active material layer 22 refers to the apparent density.

<<First Region, Second Region>>

Negative electrode active material layer 22 includes a first region, a second region, and a third region. Each of the first region and the second region, independently, includes a carbon material. The third region includes an alloy-based negative electrode active material. The first region is interposed between the second region and the third region. The first region may be in contact with the third region. The first region may surround the third region. The second region may be in contact with the first region. The second region may surround the first region.

<Method for Measuring R Value>

The R value of the first region is higher than the R value of the second region. The R value may vary depending on the composition of the region. The R value is measured by the procedure described below.

From negative electrode active material layer 22, a cross-sectional sample is taken. The cross-sectional sample includes a plane to be analyzed. The plane to be analyzed is parallel to the thickness direction of negative electrode active material layer 22. The plane to be analyzed is analyzed with a micro Raman spectrometer. Within a micrograph, a third region (alloy-based negative electrode active material) is identified. The micrograph may also be an SEM (scanning electron microscope) image, for example.

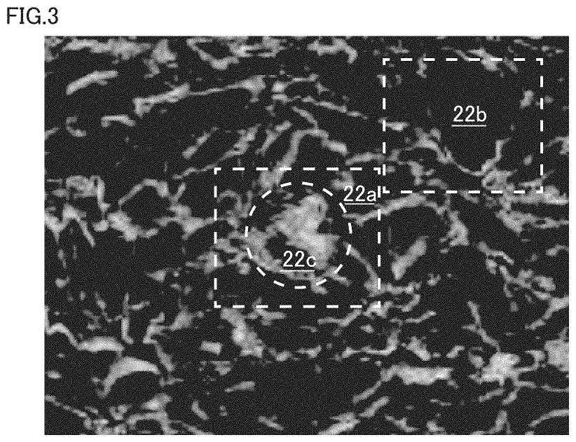

FIG. 3 is an example SEM image.

Raman imaging is carried out for a rectangular region that is centered around a third region 22c. For example, the rectangular region may be defined so that it includes an area spanning from the outline of third region 22c to 3 μm outside of the outline. For the Raman spectrum measurement, an argon ion laser is used. The range of wavenumber is from 110 cm⁻¹ to 1730 cm⁻¹. Raman imaging allows for visualizing the change in composition around third region 22c. This allows for identifying a first region 22a and a second region 22b.

As for each of the Raman spectra for first region 22a and second region 22b, the height of a peak at or near 1360 cm⁻¹ (I₁₃₆₀) and the height of a peak at or near 1580 cm⁻¹ (I₁₅₈₀ ) are measured. “At or near 1360 cm⁻¹” refers to a wavenumber band of 1360±10 cm⁻¹. “At or near 1580 cm⁻¹” refers to a wavenumber band of 1580±10 cm ⁻¹. A peak at or near 1580 cm⁻¹ is also called “G band”. It is considered that a G band is attributable to graphite crystal. A peak at or near 1360 cm⁻¹ is also called “D band”. It is considered that a D band is attributable to amorphous carbon. It is considered that a D band occurs as a result of structural defect (disorder) of graphite crystal. “I₁₃₆₀” and “I₁₅₈₀” are substituted into the equation (1) below to determine the R value of each region.

$$R = {I}_{1360} / {I}_{1580} \qquad ( 1 )$$

The R value of each region is measured at five or more positions. The arithmetic mean of the measurements for these five or more positions is regarded as the R value of the region. The R value is significant to two decimal place. It is rounded to two decimal place.

The R value of the first region may be 0.38 or more, for example. The R value of the first region may be from 0.38 to 1.40, or may be from 0.39 to 1.20, or may be from 0.40 to 1.00, or may be from 0.40 to 0.80, for example.

The R value of the second region may be less than 0.38, for example. The R value of the second region may be from 0 to 0.37, or may be from 0.01 to 0.30, or may be from 0.10 to 0.25, or may be from 0.15 to 0.20, for example.

The difference between the R value of the first region and the R value of the second region may be from 0.1 to 1, or may be from 0.1 to 0.5, or may be from 0.1 to 0.3, for example.

By the Raman imaging, for example, the area fractions of the first region, the second region, and the third region may be identified. For example, negative electrode active material layer 22 may consist of the first region in an area fraction from 30 to 49%, the second region in an area fraction from 30 to 49%, and the remainder being made up of the third region.

<First Carbon Material, Second Carbon Material>

The first region includes a first carbon material. The first region may consist essentially of a first carbon material. It seems that the R value of the first region primarily reflects the extent of graphitization of the first carbon material. The second region includes a second carbon material. The second region may consist essentially of a second carbon material. It seems that the R value of the second region primarily reflects the extent of graphitization of the second carbon material.

As long as the R value of the first region is higher than the R value of the second region, each of the first carbon material and the second carbon material may independently include an optional component. Each of the first carbon material and the second carbon material may independently include, for example, at least one selected from the group consisting of natural graphite, artificial graphite, soft carbon, hard carbon, and amorphous carbon.

As long as the R value of the first region is higher than the R value of the second region, each of the first carbon material and the second carbon material, independently, may have any configuration. For example, each of the first carbon material and the second carbon material may independently be spherical particles, flake-shaped particles, and/or the like. For example, flake-shaped particles may be spheronized into spherical particles.

Each of the first carbon material and the second carbon material, independently, may have any particle size. Each of the first carbon material and the second carbon material, independently, may have a D50 from 1 μm to 30 μm or may have a D50 from 15 μm to 25 μm, for example. Herein, “D50” is defined as a particle size in volume-based particle size distribution at which cumulative frequency accumulated from the small particle size side reaches 50%. The volume-based particle size distribution may be obtained by measurement with a laser-diffraction particle size distribution analyzer.

<Method for Adjusting R Value>

The R value may be adjusted by, for example, changing the quantitative balance between crystalline matter (graphite crystal) and amorphous matter. For example, a film may be formed on a surface of an artificial graphite particle. The film includes amorphous carbon. For example, the amount of the film may be changed to adjust the R value. The higher the amount of the film is, the higher the R value tends to be. Further, the higher the amount of the film is, the smaller the BET specific surface area tends to be.

For example, a pulse CVD (chemical vapor deposition) method may be employed to form a film on a surface of a substrate (such as an artificial graphite particle, for example). The temperature inside the chamber of the CVD apparatus may be about 1000° C., for example. Into the chamber, a feed gas is introduced. The feed gas may be about 30% propane (C₃H₈) and about 70% hydrogen (H₂) in volume fraction, for example. The duration for feed gas introduction may be about 0.1 seconds, for example. After pyrolytic carbon is deposited on the surface of the substrate, the reaction tube is evacuated of air. The pyrolytic carbon deposition and the air evacuation may be repeated to adjust the film thickness.

<First Binder, Second Binder>

As long as the R value of the first region is higher than the R value of the second region, the first region may include an additional component. For example, the first region may consist of a first binder in a mass fraction from 0 to 5%, the second carbon material in a mass fraction from 0 to 40%, and the remainder being made up of the first carbon material. For example, the first region may consist of the first binder in a mass fraction from 0.5 to 2%, the second carbon material in a mass fraction from 0 to 10%, and the remainder being made up of the first carbon material. For example, the first region may consist of the first binder in a mass fraction from 0.5 to 2% and the remainder being made up of the first carbon material.

When the first region includes the first binder, the first binder may be interposed between the first carbon material and the alloy-based negative electrode active material. The first binder may bind the first carbon material to the alloy-based negative electrode active material. With this, cycle endurance is expected to be enhanced, for example.

As long as the R value of the first region is higher than the R value of the second region, the second region may include an additional component. For example, the second region may consist of a second binder in a mass fraction from 0 to 5%, the first carbon material in a mass fraction from 0 to 40%, and the remainder being made up of the second carbon material. For example, the second region may consist of the second binder in a mass fraction from 0.5 to 2%, the first carbon material in a mass fraction from 0 to 10%, and the remainder being made up of the second carbon material. For example, the second region may consist of the second binder in a mass fraction from 0.5 to 2% and the remainder being made up of the second carbon material.

When the second region includes the second binder, the second binder may be interposed between the first carbon material and the second carbon material. The second binder may bind the first carbon material to the second carbon material. With this, cycle endurance is expected to be enhanced, for example.

Each of the first binder and the second binder may independently include an optional component. Each of the first binder and the second binder may independently include, for example, at least one selected from the group consisting of carboxymethylcellulose (CMC), styrene-butadiene rubber (SBR), polyacrylic acid (PAA), polyethylene oxide (PEO), and polytetrafluoroethylene (PTFE). Each of the first binder and the second binder may independently include, for example, at least one selected from the group consisting of CMC and SBR.

<<Third Region>>

The third region includes an alloy-based negative electrode active material. The third region may consist essentially of an alloy-based negative electrode active material. The “alloy-based negative electrode active material” herein may undergo reversible alloying reaction with lithium (Li). The specific capacity (mAh/g) of the alloy-based negative electrode active material may be higher than that of the carbon material.

The alloy-based negative electrode active material may consist essentially of a metal, for example. The metal herein also encompasses a semimetal. The alloy-based negative electrode active material may include, for example, at least one selected from the group consisting of silicon (Si), arsenic (As), tin (Sn), aluminum (Al), antimony (Sb), bismuth (Bi), zinc (Zn), indium (In), and phosphorus (P). The alloy-based negative electrode active material may include, for example, at least one selected from the group consisting of Si, Sn, In, and Al. In addition to a metal and a semimetal, the alloy-based negative electrode active material may further include a non-metal. The alloy-based negative electrode active material may consist essentially of a metal compound, for example. The alloy-based negative electrode active material may include, for example, at least one selected from the group consisting of silicon oxide (SiO) and tin oxide (SnO).

The alloy-based negative electrode active material may be particles, for example. The particle shape is not limited. The alloy-based negative electrode active material may be plate-like particles, rod-like particles, spherical particles, and/or the like, for example. The alloy-based negative electrode active material may have any particle size. The alloy-based negative electrode active material may have a D50 from 1 μm to 30 μm or may have a D50 from 1 μm to 10 μm, for example.

As long as it includes the alloy-based negative electrode active material, the third region may include an additional component. For example, a film may be formed on the surface of the alloy-based negative electrode active material (particles). The film may include amorphous carbon and/or the like, for example. The film may be formed by a CVD method and/or the like, for example.

<<Positive Electrode Plate>>

Positive electrode plate 10 may include a positive electrode substrate 11 and a positive electrode active material layer 12, for example. Positive electrode substrate 11 is a conductive sheet. Positive electrode substrate 11 may be an Al alloy foil and/or the like, for example. Positive electrode substrate 11 may have a thickness from 10 μm to 30 μm, for example. Positive electrode active material layer 12 is placed on the surface of positive electrode substrate 11. Positive electrode active material layer 12 may be placed on only one side of positive electrode substrate 11, for example. Positive electrode active material layer 12 may be placed on both sides of positive electrode substrate 11, for example. From one end in a width direction (in the X-axis direction in FIG. 2) of positive electrode plate 10, positive electrode substrate 11 may be exposed. To the exposed portion of positive electrode substrate 11, positive electrode current-collecting member 71 may be bonded.

Positive electrode active material layer 12 may have a thickness from 10 μm to 200 μm, for example. Positive electrode active material layer 12 includes a positive electrode active material. The positive electrode active material may include an optional component. The positive electrode active material may include, for example, at least one selected from the group consisting of LiCoO₂, LiNiO₂, LiMnO₂, LiMn₂O_{4,} Li(NiCoMn)O₂, Li(NiCoAl)O₂, and LiFePO₄. Here, in a composition formula such as “Li(NiCoMn)O₂”, for example, the constituents inside the parentheses (NiCoAl) are collectively regarded as a single unit in the entire composition ratio. As long as (NiCoAl) is collectively regarded as a single unit in the entire composition ratio, the composition ratios between the elements (Ni, Co, Mn) are not particularly limited.

In addition to the positive electrode active material, positive electrode active material layer 12 may further include a conductive material, a binder, and the like, for example. For example, positive electrode active material layer 12 may consist of the conductive material in a mass fraction from 1 to 10%, the binder in a mass fraction from 1 to 10%, and the remainder being made up of the positive electrode active material. Each of the conductive material and the binder may include an optional component. The conductive material may include carbon black and/or the like, for example. The binder may include polyvinylidene difluoride (PVdF) and/or the like, for example.

<<Separator>>

At least part of separator 30 is interposed between positive electrode plate 10 and negative electrode plate 20. Separator 30 separates positive electrode plate 10 from negative electrode plate 20. Separator 30 may have a thickness from 10 μm to 30 μm, for example.

Separator 30 is a porous sheet. Separator 30 allows for permeation of the electrolyte solution therethrough. Separator 30 may have an air permeability from 100 s/100 mL to 400 s/100 mL, for example. The “air permeability” herein refers to the “air resistance” defined by “JIS P 8117:2009”. The air permeability may be measured by a Gurley test method.

Separator 30 is electrically insulating. Separator 30 may include a polyolefin-based resin and/or the like, for example. Separator 30 may consist essentially of a polyolefin-based resin, for example. The polyolefin-based resin may include, for example, at least one selected from the group consisting of polyethylene (PE) and polypropylene (PP). Separator 30 may have a monolayer structure, for example. Separator 30 may consist essentially of a PE layer, for example. Separator 30 may have a multilayer structure, for example. Separator 30 may be formed, for example, by stacking a PP layer, a PE layer, and a PP layer in this order. On a surface of separator 30, a heat-resistant layer and/or the like may be formed, for example.

<<Electrolyte>>

Battery 100 may include a liquid electrolyte, or may include a gelled electrolyte, or may include a solid electrolyte, for example. For example, a solid electrolyte may separate positive electrode plate 10 from negative electrode plate 20.

The liquid electrolyte may include an electrolyte solution, an ionic liquid, and/or the like, for example. The electrolyte solution includes a solvent and a supporting electrolyte. The solvent is aprotic. The solvent may include an optional component. The solvent may include, for example, at least one selected from the group consisting of ethylene carbonate (EC), propylene carbonate (PC), butylene carbonate (BC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The supporting electrolyte is dissolved in the solvent. The supporting electrolyte may include, for example, at least one selected from the group consisting of LiPF₆, LiBF₄, and LiN(FSO₂)₂. The supporting electrolyte may have a molarity from 0.5 mol/L to 2.0 mol/L, for example. The supporting electrolyte may have a molarity from 0.8 mol/L to 1.2 mol/L, for example.

In addition to the solvent and the supporting electrolyte, the electrolyte solution may further include an optional additive. For example, the electrolyte solution may include an additive in a mass fraction from 0.01% to 5%. The additive may include, for example, at least one selected from the group consisting of vinylene carbonate (VC), lithium difluorophosphate (LiPO₂F₂), lithium fluorosulfonate (FSO₃Li), and lithium bis(oxalato)borate (LiBOB).

<Method of Producing Negative Electrode Plate>

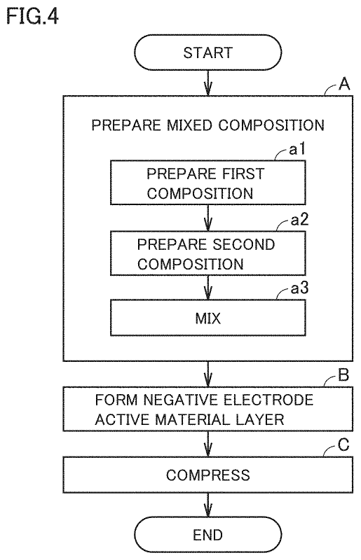

FIG. 4 is a schematic flowchart illustrating a method of producing a negative electrode plate according to the present embodiment.

The method of producing a negative electrode plate includes “(A) Preparing a mixed composition”, “(B) Forming a negative electrode active material layer”, and “(C) Compressing”.

<<(A) Preparing Mixed Composition>>

The method of producing a negative electrode plate includes preparing a mixed composition by mixing a first carbon material, a second carbon material, and an alloy-based negative electrode active material.

The materials are described above in detail. In a raw material stage, the first carbon material may have a BET specific surface area that is smaller than the second carbon material, for example. The smaller the BET specific surface area in a raw material stage is, the higher the R value of negative electrode active material layer 22 after compression tends to be. The first carbon material may have a BET specific surface area of 2 m²/g or less, for example. The first carbon material may have a BET specific surface area from 0.2 m²/g to 2 m²/g, or may have a BET specific surface area from 0.5 m²/g to 1.5 m²/g, or may have a BET specific surface area from 1.0 m²/g to 1.5 m²/g, for example. The second carbon material may have a BET specific surface area of 3.5 m²/g or more, for example. The second carbon material may have a BET specific surface area from 3.5 m²/g to 5 m²/g, or may have a BET specific surface area from 3.5 m²/g to 4.5 m²/g, or may have a BET specific surface area from 3.5 m²/g to 4.0 m²/g, for example. The “BET specific surface area” herein refers to a specific surface area calculated, by a BET multi-point method, in an absorption isotherm obtained through measurement by a gas adsorption method. The adsorbate gas is nitrogen gas.

As long as the first region, the second region, and the third region as described above may be formed, the method and the conditions for mixing the materials are not particularly limited. For example, the mixing conditions may be changed to change the crystallinity of the carbon material. More specifically, the mixing conditions may be changed to adjust the R value of each region.

The mixed composition may be a slurry composition, for example. The slurry composition may have a solid content from 40% to 80%, for example. The “solid content” refers to the sum of the mass fractions of the solid components (the components except dispersion medium) in the slurry composition. In the preparation of the slurry composition, a planetary mixer and/or the like may be used, for example.

The mixed composition may be a powder composition, for example. The powder composition may be granules or may be powder, for example. In the preparation of the powder composition, a dry particle composing machine “Nobilta (registered trademark)” manufactured by Hosokawa Micron Corporation, and/or the like may be used, for example.

The mixed composition may be prepared by mixing all the materials all at once, for example. The mixed composition may be prepared by mixing the materials sequentially, for example. The method of producing a negative electrode plate may include “(a1) Preparing a first composition”, “(a2) Preparing a second composition”, and “(a3) Mixing”, for example. The materials may be sequentially mixed to adjust the R values of the first region and the second region.

Although FIG. 4 illustrates “(a1) Preparing a first composition” and “(a2) Preparing a second composition” in this order, “(a1) Preparing a first composition” and “(a2) Preparing a second composition” may be carried out in any order. For example, “(a1) Preparing a first composition” and “(a2) Preparing a second composition” may be carried out at the same time.

<(a1) Preparing First Composition>

The method of producing a negative electrode plate may include, for example, preparing a first composition including the first carbon material, the alloy-based negative electrode active material, and a first binder. The details of the first binder are as described above. For example, the first composition may be a slurry composition or may be a powder composition. For example, the first composition may be prepared by mixing the first carbon material, the alloy-based negative electrode active material, the first binder, and a dispersion medium.

<(a2) Preparing Second Composition>

The method of producing a negative electrode plate may include, for example, preparing a second composition including the second carbon material. For example, the second composition may be a slurry composition or may be a powder composition. For example, the second composition may be prepared by mixing the second carbon material, a second binder, and a dispersion medium. That is, the second composition may further include a second binder. The details of the second binder are as described above.

<(a3) Mixing>

The method of producing a negative electrode plate may include preparing a mixed composition by mixing the first composition and the second composition. The mixing ratio between the first composition and the second composition is not particularly limited. For example, the first composition and the second composition may be mixed in a manner such that the mixing ratio between the first carbon material and the second carbon material is to be “(first carbon material)/(second carbon material)=1/9 to 9/1 (mass ratio)”. When the mixed composition is a slurry composition, for example, a dispersion medium may be added to adjust the viscosity. The dispersion medium may be selected as appropriate depending on the types of the first binder and the second binder, for example. The dispersion medium may include water and the like, for example.

<<(B) Forming Negative Electrode Active Material Layer>>

The method of producing a negative electrode plate includes forming a negative electrode active material layer including the mixed composition. For example, a negative electrode substrate is prepared. The details of the negative electrode substrate are as described above. For example, the mixed composition may be applied to the surface of the negative electrode substrate to form a negative electrode active material layer. Depending on the form of the mixed composition, a slurry applicator, a powder applicator, and/or the like may be used.

<<(C) Compressing>>

The method of producing a negative electrode plate includes compressing the negative electrode active material layer to produce a negative electrode plate. For example, the negative electrode active material layer may be compressed with the use of a rolling mill. The negative electrode active material layer is compressed in a manner such that a predetermined density is to be achieved. When the mixed composition is a powder composition, the negative electrode active material layer may be formed by compression forming, for example. In this case, forming the negative electrode active material layer and compressing the same are to be carried out substantially at the same time.

In the present embodiment, warpage in the negative electrode plate after compression may be suppressed. It may be because part of the negative electrode active material layer is constituted of a low-resilient second region. The negative electrode plate after compression may be cut into a predetermined shape, depending on the specifications of the battery.

### EXAMPLES

Next, examples according to the present technique (also called “the present example” herein) will be described. It should be noted that the below description does not limit the scope of the present technique.

<Production of Negative Electrode Plate>

The below materials were prepared.

First carbon material: artificial graphite, amorphous coated, BET specific surface area=1.2 m²/g

Second carbon material: artificial graphite, BET specific surface area=3.9 m²/g

Alloy-based negative electrode active material: Si

Binder: CMC, SBR

Dispersion medium: water

Negative electrode substrate: Cu foil

The first carbon material according to the present example was prepared by depositing pyrolytic carbon on the surface of artificial graphite by a pulse CVD method.

<<No. 1>>

The first carbon material, the alloy-based negative electrode active material, a first binder, and the dispersion medium were mixed to prepare a first composition. The first composition was a slurry composition.

The second carbon material, a second binder, and the dispersion medium were mixed to prepare a second composition. The second composition was a slurry composition.

The first composition and the second composition were mixed to prepare a mixed composition. The mixed composition was a slurry composition.

The mixed composition was applied to the surface of the negative electrode substrate to form a negative electrode active material layer. The negative electrode active material layer was compressed with the use of a rolling mill. Thus, a negative electrode plate were produced.

It seems that the negative electrode active material layer according to No. 1 includes a first region, a second region, and a third region. It seems that the first region is interposed between the second region and the third region. It seems that the first region includes the first carbon material and the first binder. It seems that the second region includes the second carbon material and the second binder. It seems that the third region includes the alloy-based negative electrode active material.

<<No. 2>>

The first carbon material, the alloy-based negative electrode active material, and the dispersion medium were mixed to prepare a first composition. Except this, the same procedure as in No. 1 was carried out to produce a negative electrode plate. The negative electrode active material layer according to No. 2 is different from the negative electrode active material layer according to No. 1 in that the first region does not include a first binder.

<<No. 3>>

The second carbon material and the dispersion medium were mixed to prepare a second composition. Except this, the same procedure as in No. 1 was carried out to produce a negative electrode plate. The negative electrode active material layer according to No. 3 is different from the negative electrode active material layer according to No. 1 in that the second region does not include a second binder.

<<No. 4>>

The alloy-based negative electrode active material, the second carbon material, a second binder, and the dispersion medium were mixed to prepare a mixed composition. The mixed composition was applied to the surface of the negative electrode substrate to form a negative electrode active material layer. The negative electrode active material layer according to No. 4 is different from the negative electrode active material layer according to No. 1 in that the former includes only one type of carbon material.

<<No. 5>>

The alloy-based negative electrode active material, the first carbon material, a first binder, and the dispersion medium were mixed to prepare a mixed composition. The mixed composition was applied to the surface of the negative electrode substrate to form a negative electrode active material layer. The negative electrode active material layer according to No. 5 is different from the negative electrode active material layer according to No. 1 in that the former includes only one type of carbon material.

<Evaluation>

<<R value>>

By the above-described procedure, the R values of the first region and the second region were measured.

<<Warpage>>

In the negative electrode plate after compression, the presence of warpage was identified.

<<Cycle Endurance>>

A test cell (a non-aqueous electrolyte secondary battery) that included the negative electrode plate was produced. The test cell was subjected to 100 cycles of charge and discharge. The discharged capacity of the 100th cycle was divided by the discharged capacity of the 1st cycle, and thereby the capacity retention was determined. The higher the capacity retention is, the better the cycle endurance is considered to be.

TABLE 1
Table 1

| | Negative electrode active material layer | | | | | | | | |
|---|---|---|---|---|---|---|---|---|---|
| | Third | | | | | | | | |
| | region | | | | | | | Evaluation | |
| | Alloy-based | | | | Second region | | | Cycle | |
| | negative | First region | | | Second | | | endurance | |
| | electrode | First carbon | | R | carbon | | R | Capacity | After |
| | active | material | | value | material | Second | value | retention | compression |
| No. | material | BET [m²/g] | First binder | [—] | BET [m²/g] | binder | [—] | [%] | Warpage 1⁾ |
| 1 | Si | 1.2 | CMC + SBR | 0.4 | 3.9 | CMC + SBR | 0.18 | 96 | P |
| 2 | Si | 1.2 | — | 0.4 | 3.9 | CMC + SBR | 0.18 | 93 | P |
| 3 | Si | 1.2 | CMC + SBR | 0.4 | 3.9 | — | 0.18 | 94 | P |
| 4 | Si | — | — | — | 3.9 | CMC + SBR | 0.18 | 92 | P |
| 5 | Si | 1.2 | CMC + SBR | 0.4 | — | — | — | 97 | f |

1⁾ “p (pass)” means that no warpage was observed. “f (fail)” means that warpage was observed.

### RESULTS

Table 1 above shows a tendency that cycle endurance is good and warpage is suppressed when the R value of the first region is higher than the R value of the second region.

Table 1 above shows a tendency that cycle endurance is enhanced when the first region includes a first binder.

Table 1 above shows a tendency that cycle endurance is enhanced when the first region includes a first binder and the second region includes a second binder.

The present embodiment and the present example are illustrative in any respect. The present embodiment and the present example are non-restrictive. The scope of the present technique encompasses any modifications within the meaning and the scope equivalent to the terms of the claims. For example, it is expected that certain configurations of the present embodiments and the present examples can be optionally combined.

What is claimed is:

1. A negative electrode plate for a non-aqueous electrolyte secondary battery, comprising:
a negative electrode active material layer, wherein
the negative electrode active material layer includes a first region, a second region, and a third region,
the first region is interposed between the second region and the third region,
the first region includes a first carbon material,
the second region includes a second carbon material,
the third region includes an alloy-based negative electrode active material,
an R value of the first region is higher than an R value of the second region, and
the R value is determined by an equation (1):
$$R = {I}_{1360} / {I}_{1580} \qquad ( 1 )$$
where
R denotes the R value,
I₁₃₆₀ denotes an intensity of a peak at or near 1360 cm⁻¹ in a Raman spectrum, and
I₁₅₈₀ denotes an intensity of a peak at or near 1580 cm⁻¹ in the Raman spectrum.

2. The negative electrode plate according to claim 1, wherein
the R value of the first region is 0.38 or more, and
the R value of the second region is less than 0.38.

3. The negative electrode plate according to claim 1, wherein the first region further includes a first binder.

4. The negative electrode plate according to claim 1, wherein the second region further includes a second binder.

5. A non-aqueous electrolyte secondary battery comprising the negative electrode plate according to claim 1.

6. A method of producing a negative electrode plate for a non-aqueous electrolyte secondary battery, the method comprising:
preparing a mixed composition by mixing a first carbon material, a second carbon material, and an alloy-based negative electrode active material;
forming a negative electrode active material layer including the mixed composition; and
compressing the negative electrode active material layer to produce a negative electrode plate, wherein
the negative electrode active material layer is formed so as to include a first region, a second region, and a third region,
the first region is interposed between the second region and the third region,
the first region includes the first carbon material,
the second region includes the second carbon material,
the third region includes the alloy-based negative electrode active material,
the first region is formed so as to have an R value higher than an R value of the second region, and
the R value is determined by an equation (1):
$$R = {I}_{1360} / {I}_{1580} \qquad ( 1 )$$
where
R denotes the R value,
I₁₃₆₀ denotes an intensity of a peak at or near 1360 cm⁻¹ in a Raman spectrum, and
I₁₅₈₀ denotes an intensity of a peak at or near 1580 cm⁻¹ in the Raman spectrum.

7. The method of producing a negative electrode plate according to claim 6, wherein
the first carbon material has a BET specific surface area of 2 m²/g or less, and
the second carbon material has a BET specific surface area of 3.5 m²/g or more.

8. The method of producing a negative electrode plate according to claim 6, comprising:
preparing a first composition including the first carbon material, the alloy-based negative electrode active material, and a first binder;
preparing a second composition including the second carbon material; and
preparing the mixed composition by mixing the first composition and the second composition.

9. The method of producing a negative electrode plate according to claim 8, wherein the second composition further includes a second binder.
